(19) United States
(12) Patent Application Publication
(10) Pub. No.: US 2006/0222788 A1
(43) Pub. Date: Oct. 5, 2006

(54) Recording medium

(75) Inventors: Jacko Hessing, Rijen (NL); Akira Kase, Tilburg (NL)

Correspondence Address: BANNER & WITCOFF, LTD., 28 STATE STREET, 28th FLOOR, BOSTON, MA, 02109-9601, US

(73) Assignee: Fuji Photo Film B.V., Tiburg (NL)

(21) Appl. No.: 11/397,056

(22) Filed: Apr. 3, 2006

Related U.S. Application Data
(63) Continuation of application No. PCT/NL04/00689, filed on Oct. 4, 2004.

(30) Foreign Application Priority Data
Oct. 3, 2003 (EP) 03078119.9

(51) Int. Cl. B41M 5/00

(52) U.S. Cl. 428/32.24

(57) ABSTRACT

The present invention relates to a recording medium, in particular an ink-jet recording medium of photographic quality that has excellent color stability while keeping good ink absorption speed, good drying characteristics and a good image printing quality. According to the present invention an ink-jet recording medium is provided, comprising a support to which at least an underlayer and an overlayer is supplied, wherein one layer comprising an optical brightener is further away from said support than another layer which comprises a UV absorbing agent. The present invention is further directed to methods for obtaining and using such a medium.

### RELATED APPLICATIONS

This application is a continuation of PCT application no. PCT/NL/2004/000689, designating the United States and filed Oct. 4, 2004; which claims the benefit of the filing date of European application no. EP 03078119.9, filed Oct. 3, 2003; both of which are hereby incorporated herein by reference in their entirety.

### FIELD OF THE INVENTION

The present invention relates generally to a recording medium, in particular an ink-jet recording medium of photographic quality that has excellent ink absorption speed, good drying characteristics and a good image printing quality, in particular a good lightfastness and whiteness, as well as to methods for preparing and using such media.

### BACKGROUND OF THE INVENTION

In a typical ink-jet recording or printing system, ink droplets are ejected from a nozzle at high speed towards a recording element or medium to produce an image on the medium. The ink droplets, or recording liquid, generally comprise a recording agent, such as a dye, and a relatively large amount of solvent in order to prevent clogging of the nozzle. The solvent, or carrier liquid, typically is made up of water, and organic material such as monohydric alcohols and the like. An image recorded as liquid droplets requires a receptor on which the recording liquid dries quickly without running or spreading. High quality image reproduction using ink-jet printing techniques requires receptor substrates, typically sheets of paper or opaque or transparent film, that readily absorb ink droplets while preventing droplet diffusion or migration. Good absorption of ink encourages image drying while minimizing dye migration by which good sharpness of the recorded image is obtained.

A further important property of inkjet media is that they should provide for a good lightfastness, viz. the printed images must not fade over longer periods of time.

In order to improve the lightfastness of inkjet media, several approaches have been suggested in the prior art. JP-A-4 201 594, for instance, proposes to include hyperfine powder of transition metal oxides in the ink accepting layer and GB-A-2 147 003 suggests to combine metal salts with cationic polymeric substances to improve lightfastness of the produced images. Furthermore, JP-A-2002/220 559 and EP-A-0 869 010 describe a specific copolymer, which is to be included in one or more of the layers of the inkjet media, to improve lightfastness.

JP-A-2000/280 601 discloses inkjet recording media wherein the lightfastness is improved by incorporating a UV absorbent in a protective layer of the media. EP-A-1 059 173 describes a two-layer inkjet recording medium comprising alumina hydrate particles, a water soluble optical brightener and a UV absorbent. Good adhesion and a good light fastness are claimed.

Although the above-mentioned prior art documents may contribute to improved lightfastness, in general the suggested measures give rise to a paper having less whiteness or of which the whiteness deteriorates after aging. The medium's whiteness may be improved by combining the UV absorbent with an optical brightener. However, it was found that this does not necessarily improve the medium's quality with respect to whiteness.

Thus there remains a need for ink-jet materials having good lightfastness combined with an acceptable whiteness. At the same time this material should provide for good image printing quality, good drying properties, good curl and brittleness, having at the same time good behavior on bleed, beading and matte appearance at high density parts and also be available at low cost. It is towards fulfilling these needs that the present invention is directed.

### SUMMARY OF THE INVENTION

The object of the present invention is to provide an ink-jet recording medium having good overall properties, said recording medium more in particular being suited to produce images of photographic quality, wherein said medium has an improved lightfastness and whiteness.

At the same time it is desirable that the media of the present invention maintain other favorable properties with respect to brittleness at low humidities, curl behavior, beading, matt appearance at high densities and bleeding properties.

It is another object of the present invention to provide an ink-jet recording medium with reduced brittleness at low humidities and excellent curl behaviour.

It is a further object of this invention, to provide an ink-jet recording medium which gives no beading and has no matte appearance at high densities and has good bleeding properties.

It has been found that these objectives can be met by providing a recording medium comprising a support and an ink-receiving layer adhered to said support, where the ink receiving layer is a multilayer comprising at least two layers, wherein one layer comprising an optical brightener is further away from said support than another layer which comprises a UV absorbing agent.

### DETAILED DESCRIPTION

The invention is directed to a recording medium comprising a support and an ink-receiving layer adhered to said support, where the ink receiving layer is a multilayer comprising at least two layers, the first layer being closer to the support than the second layer, the first layer comprising a UV absorbing agent and the second layer comprising an optical brightener. Thus in accordance with the present invention the optical brightener comprising layer is above the UV absorbing agent comprising layer.

It was found that best results are obtained if the UV absorbing agent and the optical brightener are kept separated from each other by maintaining them in separate layers as much as possible, not only during preparation of the media but also upon storage.

Thus the present inventors have found that the use of certain types of optical brighteners are less suitable or even unsuitable for use in multilayer inkjet recording media, because they can migrate through the polymeric material by diffusion and thus be transported from one layer to the other. This is in particular the case for water soluble polymers, such as those described in EP-A-1 059 173 (Tinopal™ SFP). Therefore the optical brighteners used in the present invention are preferably fixable in one layer. This may suitably be obtained by employing non-watersoluble optical brighteners. It is noted however, that in principle it is also possible to fix the position of even water soluble optical brighteners, e.g. by reacting them with the polymers of the layer in which they are to be fixed.

Similarly, water soluble UV absorbing agents are also less preferred. Preferably the UV absorbing agent containing layer is free or essentially free from optical brightener. In another preferred embodiment the optical brightener containing layer is free or essentially free from UV absorbing agent. More preferably both the UV absorbing agent containing layer is (essentially) free from optical brightener and the optical brightener containing layer is (essentially) free from UV absorbing agent.

In the conventional media for ink-jet application comprising at least one ink receiving layer based on a water soluble polymer, such as gelatin, polyvinylalcohol (PVA), PEO, hydroxyethylcellulose and the like and mixtures of these polymers, it is possible to obtain good drying characteristics but it is difficult to obtain an image with photographic quality due to the color instability of the printed image. Color instability means that the printed dyes deteriorate when exposed to light, and that the whiteness of the unprinted parts of the recording material decreases under high temperature and humidity. Adding UV-absorbing agents may improve the printed dye stability, but generally results in yellowing upon aging.

The present inventors have found that the color instability can be improved significantly by adding UV absorbing agents and optical brighteners while taking measures so that the optical brightener is present in a layer that is further away from the support than a layer, or layers, comprising UV-absorbing agents, achieving considerable improvements in lightfastness and while keeping good whiteness after aging.

Both the overlayer and the underlayer of this invention may be a multilayer of sublayers. The total number of sublayers is not particularly limited and depends largely on the available technique for application of layers and the required ink receiving properties of the ink receiving layer. The total number of sublayers may be from 2 to 25, more preferably from 2 to 17.

Optical brighteners are compounds that absorb UV light between 300 and 400 nm and have a strong fluorescence in the blue region of the spectrum. Optical brighteners are in accordance with the present invention located further away from the substrate on which the ink receiving layer is coated than the UV absorber. It has been found that in this manner brightening is more effective and the optical brightener also serves as a UV absorber.

Suitable UV-absorbing agents are disclosed e.g. in RD24239, RD290119, RD30326 and comprise the families of cinnamates, hydroxybenzophenones, benzotriazoles and aminobutadienes or a combination thereof. Preferred UV-absorbers are benzotriazoles, more preferably hydroxyphenylbenzotriazoles.

Preferably the UV absorbing groups absorb at a wavelength of less than 400 nm. Less preferred are UV absorbing groups of which the absorption extends somewhat beyond 400 nm, since these can have a yellowish color.

The UV-absorber is present in the ink receiving layer in an amount of 0.1 to 5.0 gram/m2, preferably of 0.2 to 1.0 gram/m2.

Suitable optical brighteners are disclosed in e.g. RD11125, RD9310, RD8727, RD8407, RD36544 or Ullmann's Encyclopedia of industrial chemistry (Vol. A18, p. 153-167), and comprise thiophenes, stilbenes, triazines, imidazolones, pyrazolines, triazoles, bis(benzoxazoles), coumarins and acetylenes. The optical brightener is present in the ink receiving layer in an amount of 0.01 to 5.0 gram/m2, preferably of 0.02 to 1.0 gram/m2.

Optical brighteners and UV absorbing agents are preferably not water soluble, and can suitably be dispersed in a layer by adding the compounds as solutions in low boiling organic solvents like for example ethylacetate, butylacetate or n-butanol or as dispersions using a homogenizer. Also, the compounds can be dissolved in a high boiling organic solvent or a mixture thereof, optionally together with at least one low boiling organic solvent, the resulting oily solution then being emulsified in an aqueous gelatin solution in the presence of a surface active agent.

Suitable high boiling organic solvents comprise phtalic acid esters, phosphoric acid or phosphonic acid esters, benzoic acid esters, sulfonamides, alcohols or phenols, aliphatic carboxylic acid esters, aniline derivatives, hydrocarbons and chlorinated paraffins.

Suitable low boiling organic solvents to be used with the high boiling organic solvents are for example ethylacetate, butylacetate, ethylpropionate, methylethylketon, cyclohexanon, 2-ethoxyethylacetate and dimethylformamide.

HLB (Hydrophile-Lipophile Balance) is a well known parameter for surfactants, used to make a first selection of the surfactants for an application. Suitable surface active agents for preparing oil-in-water emulsions are preferably those having a HLB number of between 8 and 18, for example alkylbenzenesulphonates, alkylglucosides, alkylphenolethoxylates, alkylphosphates, and the like.

Methods for preparing oil in water emulsions are described in, for example, research disclosure 37038.

In one embodiment a layer comprising a UV absorbing agent is adhered to the support and on top of this layer is a layer comprising an optical brightener, together forming the underlayer. On top of this underlayer an overlayer is present. In another embodiment the ink-receiving layer comprises at least one underlayer, a layer comprising an UV absorbing agent on top of the underlayer(s), an optical brightener layer on top of the UV absorbing layer and an overlayer on top of the optical brightener layer. The optical brightening layer(s) and UV absorbing layers may comprise any component that is also used in an underlayer or overlayer. When discussing further embodiments of the underlayer(s) or overlayer(s) these also include optical brightening layers and UV absorbing layers.

Although porous particles may be added to the ink receiving layer in order to enhance the liquid absorbing properties of the recording medium, for the current invention the presence of (inorganic) porous particles such as silica, alumina hydrate, CaCO3, clay, titanium dioxide and the like is not required.

Preferably, the dye stabilizing layer(s) or optical brightening layers also comprise an anti-oxidant. Most preferably the anti-oxidant is added at least in the optical brightener layer. Suitable anti-oxidants are disclosed in e.g. RD31980, RD31429, RD30326 and comprise substituted phenolic and blocked phenolic compounds, phenolic thiane derivatives, substituted bisphenols, sterically hindered amines, hydrochinon and agents having molecular structures which are based upon a cresol type of molecule, a pyrogallol type, a cathechol type, or a 2,4-disulphonamidophenol type. The anti-oxidant is present in the ink receiving layer in an amount of 0.05 to 2.5 gram/m², preferably of 0.1 to 1.0 gram/m².

In the ink receiving layer, the underlayer especially determines the physical and ink receiving properties like drying speed, brittleness and curl and can comprise any combination of polymers with gelatin known in the art as described for example in EP-A-0 594 896.

There is a variety of gelatins, both non-modified as well as modified gelatins which can be used in the underlayer. Examples of non-modified gelatins are alkali-treated gelatin (cattle bone or hide gelatin), acid-treated gelatin (pigskin, cattle/pig bone gelatin), or hydrolyzed gelatin. Examples of modified gelatins are acetylated gelatin, phthalated gelatin, quaternary ammonium modified gelatin, et cetera. These gelatins can be used singly or in combination for forming the underlayer. Acid and alkali treated gelatins are preferred. Also recombinant gelatins, like for example described in WO-A-02/052342, can be applied.

Water soluble polymers suitable to be mixed with the (modified) gelatin include polyvinyl alcohol-(PVA-)based polymers, such as fully hydrolysed or partially hydrolysed polyvinyl alcohol (PVA), carboxylated polyvinyl alcohol, copolymers and terpolymers of PVA with other polymers, watersoluble cellulose derivatives such as hydroxyethyl cellulose, methyl cellulose, hydroxypropyl cellulose, carboxymethyl cellulose, casein, gum arabic, polyacrylic acid and its copolymers or terpolymers, and any other polymer, which contain monomers of carboxylic acids such as acrylic acid, methacrylic acid, maleic acid and crotonic acid, polyvinylpyrolidone (PVP), polyethylene oxide, polyacrylamide, 2-pyrrolidone and its derivatives, such as N (2-hydroxyethyl)-2-pyrrolidone and N-cyclohexyl-2-pyrrolidone, urea and its derivatives such as imidazolidinyl urea, diazolidinyl urea, 2-hydroxyethylethylene urea, and ethylene urea.

Most of the water soluble polymers have very limited compatibility with gelatin. These polymers include fully hydrolyzed or partially hydrolyzed polyvinyl alcohol, hydroxyethyl cellulose, methyl cellulose, hydroxypropyl cellulose, polyethylene oxide, polyacrylamide, and the like. When a solution of gelatin in water is mixed with a solution in water of one of the above described polymers, micro or macro phase separation occurs in solution which persists in the dried coating. The dried coating exhibits high haze, low transparency, and low gloss. The system of a mixture of gelatin and a water soluble polymer is very well illustrated by means of a gelatin/PEO mixture as example. A homogeneous gelatin PEO mixture, i.e. a mixture where no phase separation occurs, may be obtained by adjusting the pH of the mixture. However there is no unique rule to determine the pH at which there is no phase separation. The best way is to follow the practical approach by making the required mixture of gelatin and water soluble polymer in water and adding alkali or acid until a homogeneous solution is obtained. The suitable pH range mainly depends on the gelatin type used and type of the water soluble polymer. It was found that modified acid treated gelatins having an iso-electric-point (IEP) of between 6 and 1 give a homogeneous solution with polyethylene oxide (PEO) at a pH below 4. At pH between 5 and 10, the mixture remains turbid, which indicate that the mixture is not homogeneous. At a pH higher than 11, a homogeneous solution can be obtained. For a lime treated gelatin, that may have an IEP value of between 4 and 6, a homogeneous mixture between gelatin and PEO can be obtained at a broader pH ranges, i.e. at a pH value lower than 4.5 or at a pH value higher than 6.

In addition to the above mentioned pH adjustment, we have found, that it is not only important to have a homogeneous solution, but it is also beneficial to have a molecular weight of PEO of at least 100 000. A lower MW might also give satisfactory results, but in general most of the important properties, like curling, drying speed and brittleness improve when using a high MW PEO. In addition to this, it appeared to be beneficial to use an underlayer comprising various layers, in which the various layers have a different gelatin/PEO ratio. We have found that a low gelatin/PEO ratio in the layer adjacent to the overlayer and a higher gelatin/PEO ratio at the layers nearer to the support have a beneficial effect on properties like bleeding and beading. More specifically gelatin/PEO ratios (wt./wt.) in the layer nearest to the overlayer preferably vary between 1/1 to 8/1 and the gelatin/PEO ratios (wt./wt.) in the layers nearest to the support should vary between 1/1 and 12/1 with the condition, that the gelatin/PEO ratio of the layer adjacent to the overlayer is always lower, than the ratio of the other gelatin-PEO layers. When using more gelatin-PEO layers in the underlayer it is further beneficial to use a gradient for the gelatin/PEO ratio, meaning, that the gelatin/PEO ratio is lowest in the layer adjacent to the overlayer and said ratio is highest for the layer most near to the substrate.

The homogeneous gelatin-PEO solution of the underlayer, which is supplied to the substrate has a gelatin concentration between 5 and 20 wt. %.

In one embodiment of the present invention PEO is used. Similar results can be obtained for mixtures of gelatin and other water soluble polymers having a limited compatibility with each other. One may substitute the PEO with other water soluble polymers mentioned above such as PVP or PVA or a mixture between two or more water soluble polymers such as PEO and PVP. The ratio between the gelatin and said water soluble polymer(s) is preferably in the same ranges as described above for gelatin-PEO system.

Good results are obtained with PVA-based polymers. In general a large variety of PVA-based polymers can be used, but the preferred PVA-based polymers are those which have been modified to give a good miscibility with aqueous gelatin solutions. These modifications are such, that in the PVA-based polymer back bone groups are introduced which provide a hydrogen bonding site, an ionic bonding site, carboxylic groups, sulphonyl groups, amide groups and the like, thus providing a modified PVA-based polymer. A modified PVA-based polymer giving very good results is a poly(vinyl alcohol)-co-poly(n-vinyl formamide) copolymer (PVA-NVF). Very suitable PVA-NVF copolymers for use with the present invention are the copolymers described in WO-A-03/054029, which have the general formula I:

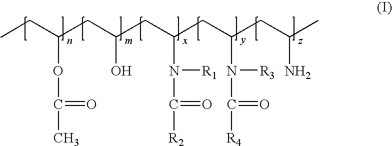

wherein

n is between 0 and about 20 mole percent;

m is between about 50 and about 97 mole percent;

x is between 0 and about 20 mole percent;

y is between 0 and about 20 mole percent;

z is between 0 and about 2 mole percent and

x+y is between about 3 and about 20 mole percent;

R₁, and R₃ are independently H, 3-propionic acid or C₁-C₆ alkyl ester thereof, or is 2-methyl-3-propionic acid or C₁-C₆ alkyl ester thereof; and

R₂ and R₄ are independently H or C₁-C₆ alkyl.

The water soluble polymer is preferably applied for the underlayer in an amount ranging from 0.5 to 15 g/m², more preferably from 1.0 to 8.0 g/m².

The underlayer can be a multilayer of sublayers. It was found that in case the underlayer is a multilayer it is beneficial to apply different concentrations of gelatin and water soluble polymer in the sublayers of the underlayer. A lower concentration of gelatin and water soluble polymer in the sublayer closest to the support enables a lower viscosity of the mixture which improves the coatability and allows higher coating speeds.

In a specific embodiment between the support and the underlayer an adhesion promoting layer is applied to enhance the adhesion of the coated layers onto the support. This adhesion promoting layer may be coated in a separate step or simultaneously with the receiving layers.

The overlayer or top layer determines the surface properties like beading and gloss. The overlayer preferably comprises a modified gelatin, and may further comprise water insoluble particles inter alia to regulate the slip behavior and optionally one or more water soluble polymers, surfactants and other additives to optimize the surface properties.

The term “modified gelatin” as used herein, refers to gelatin compounds in which at least part of the NH₂ groups is chemically modified. A variety of modified gelatins can be used in the overlayer. Good results are obtained, when at least 30% of the NH₂ groups of the gelatin is modified by a condensation reaction with a compound having at least one carboxylic group as described among others in DE-A-19721238. The compound having at least one carboxylic group can have an other functional group like a second carboxylic group and a long aliphatic tail, which in principle is not modified. Long tail in this context means from at least 5 to as much as 25 C atoms. This aliphatic chain can be modified still to adjust the properties like water solubility and ink receptivity. Preferred modified gelatins comprise an alkyl group (more preferably a C₅-C₂₅-alkyl group), a fatty acid group (more preferably C₅-C₂₅-fatty acid group), or both. Even more preferably the gelatins comprise a C₇-C₁₈-alkyl group, a C₇-C₁₈-fatty acid group, or both. Especially preferred gelatins of this type are succinic acid modified gelatins in which the succinic acid moiety contains an aliphatic chain from at least 5 to 25 carbon-atoms, where the chain can still be modified to a certain extend to adjust the water soluble properties or ink receptive properties. Most preferred is the use of dodecenylsuccinic acid modified gelatin, in which at least 30% of the NH₂ groups of the gelatin have been modified with said dodecenylsuccinic acid.

Other suitable methods for obtaining the modified gelatin are described in EP-A-0576911, by V. N. Izmailova et al. (Colloid Journal, vol. 64, No. 5, 2002, pages 640-642), and by O. Toledano et al. (Journal of Colloid and Interface Science 200, pages 235-240).

Other suitable modified gelatins giving good results are gelatins modified to have quaternary ammonium groups. An example of such a gelatin is the “Croquat™” gelatin produced by Croda Colloids Ltd. Still another modified gelatin known in the common gelatin technology, such as phtalated gelatin and acetylated gelatins are also suitable to be used in the top layer.

The modified gelatin can be used alone or in combination with another water soluble polymer. Examples of these polymers include: fully hydrolysed or partially hydrolysed polyvinyl alcohol, hydroxyethyl cellulose, methyl cellulose, hydroxypropyl cellulose, polyvinylpyrolidone, any gelatin whether lime-processed or acid processed made from animal collagen, preferably gelatin made from pig skin, cow skin, pig bone or cow bone, polyethylene oxide, polyacrylamide, and the like. The modified gelatin is applied in the overlayer in an amount ranging from 0.3 to 5 g/m² and most preferably from 0.5 to 3 g/m². A suitable amount of the water soluble polymer in said mixture is varying between 0 and 75 wt % of the amount of the modified gelatin. In case said water soluble polymer amount is higher than 75 wt %, the advantages of the modified gelatin may become less pronounced. The mere application of the modified gelatin or mix of modified gelatin and water soluble polymers improves the characteristics with respect to drying and finger smearing properties.

A further improvement of above mentioned properties can be obtained by including in the overcoating a fluorosurfactant in the amount between 2.5 mg/m² and 250 mg/m². This kind of surfactants improves amongst others the gloss and beading. Beading is defined as the phenomenon that large ink dots become visible on the printed image. The mechanism of “beading” is not clear yet. One hypothesis is that several small ink drops coalesce with each other on the surface of the ink jet media and form large ink droplets.

The term “fluorosurfactant” as used herein, refers to surfactants (viz. molecules having a hydrophilic and a hydrophobic part) that contain fluorocarbon or a combination of fluorocarbon and hydrocarbon as the hydrophobic part. Suitable fluorosurfactants may be anionic, non-ionic or cationic. Examples of suitable fluorosurfactants are: fluoro C₂-C₂₀ alkylcarboxylic acids and salts thereof, disodium N-perfluorooctanesulfonyl glutamate, sodium 3-(fluoro-C₆-C₁₁ alkyloxy)-1-C₃-C₄ alkyl sulfonates, sodium 3-(omega-fluoro-C₆-C₈ alkanoyl-N-ethylamino)-1-propane sulfonates, N-[3-(perfluorooctanesulfonamide)-propyl]-N,N-dimethyl-N-carboxymethylene ammonium betaine, perfluoro alkyl carboxylic acids (e.g. C₇-C₁₃ alkyl carboxylic acids) and salts thereof, perfluorooctane sulfonic acid diethanolamide, Li, K and Na perfluoro C₄-C₁₂ alkyl sulfonates, Li, K and Na N-perfluoro C₄-C₁₃ alkane sulfonyl —N— alkyl glycine, fluorosurfactants commercially available under the name Zonyl® (produced by E.I. Du Pont) that have the chemical structure of R_{f}CH₂CH₂SCH₂CH₂CO₂Li or R_{f}CH₂CH₂O(CH₂CH₂O)ₓ H wherein R_{f}=F(CF₂CF₂)₃₋₈ and x=0 to 25, N-propyl-N-(2-hydroxyethyl)perfluorooctane sulfonamide, 2-sulfo-1,4-bis(fluoroalkyl)butanedioate, 1,4-bis(fluoroalkyl)-2-[2-N,N,N-trialkylammonium)alkyl amino]butanedioate, perfluoro C₆-C₁₀ alkylsulfonamide propyl sulfonyl glycinates, bis-(N-perfluorooctylsulfonyl-N-ethanolaminoethyl)phosphonate, mono-perfluoro C₆-C₁₆ alkyl-ethyl phosphonates, and perfluoroalkylbetaine.

Also useful are the fluorocarbon surfactants described e.g. in U.S. Pat. No. 4,781,985 and in U.S. Pat. No. 5,084,340. Preferably the fluorosurfactant is chosen from Li, K and Na N-perfluoro C₄-C₁₃ alkane sulfonyl —N— alkyl glycine, 2-sulfo-1,4-bis(fluoroalkyl)butanedioate, 1,4-bis(fluoroalkyl)-2-[2-(N,N,N-trialkylammonium alkyl amino]butanedioate, perfluoroalkyl subsitituted carboxylic acids commercially available under the name Lodyne® (produced by Ciba Specialty Chemicals Corp.) and fluorosurfactants commercially available under the name Zonyl® (produced by E.I. Du Pont) that have the chemical structure of R_{f}CH₂CH₂SCH₂CH₂CO₂Li or R_{f}CH₂CH₂O(CH₂CH₂O)ₓ H wherein R_{f}=F(CF₂CF₂)₃₋₈ and x=0 to 25.

Beside the modified gelatin or modified gelatin/water soluble polymer mixture and fluorosurfactant it may be desirable to add in the overlayer an anti-blocking agent to prevent image transfer when several printed inkjet media are stacked. Very suitable anti-blocking agents (also known as matting agents) have a particle size from 1 to 20 μm, preferably between 2 and 10 μm. The amount of matting agent is from 0.01 to 1 g/m², preferably from 0.02 to 0.5 g/m². The matting agent can be defined as particles of inorganic or organic materials capable of being dispersed in a hydrophilic organic colloid. The inorganic matting agents include oxides such as silicon oxide, titanium oxide, magnesium oxide and aluminium oxide, alkali earth metal salts such as barium sulphate, calcium carbonate, and magnesium sulphate, and glass particles. Besides these substances one may select inorganic matting agents which are disclosed in West German Patent No. 2,529,321, British Patent Nos. 760,775 and 1,260,772, U.S. Pat. Nos. 1,201,905, 2,192,241, 3,053,662, 3,062,649, 3,257,296, 3,322,555, 3,353,958, 3,370,951, 3,411,907, 3,437,484, 3,523,022, 3,615,554, 3,635,714, 3,769,020, 4,021,245 and 4,029,504. The organic matting agents include starch, cellulose esters such as cellulose acetate propionate, cellulose ethers such as ethyl cellulose, and synthetic resins. The synthetic resins are water insoluble or sparingly soluble polymers which include a polymer of an alkyl(meth)acrylate, an alkoxyalkyl(meth)acrylate, a glycidyl(meth)acrylate, a (meth)acrylamide, a vinyl ester such as vinyl acetate, acrylonitrile, an olefin such as ethylene, or styrene and a copolymer of the above described monomer with other monomers such as acrylic acid, methacrylic acid, alpha, beta-unsaturated dicarboxylic acid, hydroxyalkyl(meth)acrylate, sulfoalkyl(meth)acrylate and styrene sulfonic acid. Further, a benzoguanamin-formaldehyde resin, an epoxy resin, nylon, polycarbonates, phenol resins, polyvinyl carbazol or polyvinylidene chloride can be used. Besides the above are used organic matting agents which are disclosed in British Patent No. 1,055,713, U.S. Pat. Nos. 1,939,213, 2,221,873, 2,268,662, 2,322,037, 2,376,005, 2,391,181, 2,701,245, 2,992,101, 3,079,257, 3,262,782, 3,443,946, 3,516,832, 3,539,344,554, 3,591,379, 3,754,924 and 3,767,448, Japanese Patent O.P.I. Publication Nos. 49-106821/1974 and 57-14835/1982. These matting agents may be used alone or in combination.

The overlayer may optionally include thickener agents, biocides crosslinking agents and further various conventional additives such as colorants, colored pigments, pigment dispersants, mold lubricants, permeating agents, fixing agents for ink dyes, anti-oxidants, light stabilising agents, dispersing agents, anti-foaming agents, leveling agents, fluidity improving agents, antiseptic agents brightening agents, viscosity stabilizing and/or enhancing agents, pH adjusting agents, anti-mildew agents, antifungal agents, agents for moisture-proofing, agents for increasing the stiffness of wet paper, agents for increasing the stiffness of dry paper and anti-static agents.

The above-mentioned various additives can be added ordinarily in a range of 0 to 10 weight % based on the solid content of the ink receiving layer composition.

In another embodiment the modified gelatin and the fluorosurfactant can be added in separate overlayer coatings, meaning, that also the overlayer is a multilayer. In this case it is preferable to have the fluorosurfactant in a coating layer farthest away from the substrate and the modified gelatin applied under this coating.

The ink receiving layer may further contain the following ingredients in order to improve its properties with respect to ink receptivity and strength:

One or more plasticizers, such as ethylene glycol, diethylene glycol, propylene glycol, polyethylene glycol, glycerol monomethylether, glycerol monochlorohydrin, ethylene carbonate, propylene carbonate, tetrachlorophthalic anhydride, tetrabromophthalic anhydride, urea phosphate, triphenylphosphate, glycerolmonostearate, propylene glycol monostearate, tetramethylene sulfone, N-methyl-2-pyrrolidone, N-vinyl-2-pyrrolidone, and polymer lattices with low Tg-value such as polyethylacrylate, polymethylacrylate and the like.

One or more fillers; both organic and inorganic particles can be used as fillers. Useful filler examples are represented by silica (colloidal silica), alumina or alumina hydrate (aluminazol, colloidal alumina, a cat ion aluminum oxide or its hydrate and pseudo-boehmite), a surface-processed cat ion colloidal silica, aluminum silicate, magnesium silicate, magnesium carbonate, titanium dioxide, zinc oxide, calcium carbonate, kaolin, talc, clay, zinc carbonate, satin white, diatomaceous earth, synthetic amorphous silica, aluminum hydroxide, lithopone, zeolite, magnesium hydroxide and synthetic mica. Useful examples of organic fillers are represented by polystyrene, polymethacrylate, polymethyl-methacrylate, elastomers, ethylene-vinyl acetate copolymers, polyesters, polyester-copolymers, polyacrylates, polyvinylethers, polyamides, polyolefins, polysilicones, guanamine resins, polytetrafluoroethylene, elastomeric styrene-butadiene rubber (SBR), urea resins, urea-formalin resins. Such organic and inorganic fillers may be used alone or in combination.

One or more mordants. Mordants may be incorporated in the ink-receptive layer of the present invention. Such mordants are represented by cationic compounds, monomeric or polymeric, capable of complexing with the dyes used in the ink compositions. Useful examples of such mordants include quaternary ammonium block copolymers. Other suitable mordants comprise diamino alkanes, ammonium quaternary salts and quaternary acrylic copolymer latexes. Other suitable mordants are fluoro compounds, such as tetra ammonium fluoride hydrate, 2,2,2-trifluoroethylamine hydrochloride, 1-(alpha, alpha, alpha-trifluoro-m-tolyl) piperazine hydrochloride, 4-bromo-alpha, alpha, alpha-trifluoro-o-toluidine hydrochloride, difluorophenylhydrazine hydrochloride, 4-fluorobenzylamine hydrochloride, 4-fluoro-alpha, alpha-dimethylphenethylamine hydrochloride, 2-fluoroethylaminehydrochloride, 2-fluoro-1-methylpyridinium-toluene sulfonate, 4-fluorophenethylamine hydrochloride, fluorophenylhydrazine hydrochloride, 1-(2-fluorophenyl)piperazine monohydrochloride, 1-fluoro pyridinium trifluoromethane sulfonate.

One or more additives, such as:
pigments: white pigments such as titanium oxide, zinc oxide, talc, calcium carbonate and the like; blue pigments or dyes such as cobalt blue, ultramarine or phthalocyanine blue; magenta pigments or dyes such as cobalt violet, fast violet or manganese violet;
biocides;
pH controllers;
preservatives;
viscosity modifiers;
dispersing agents;
anti-oxidants;
antistatic agents; and/or
anionic, cationic, non-ionic, and/or amphoteric surfactants, typically used in amounts ranging from 0.1 to 1000 mg/m², preferably from 0.5 to 100 mg/m².

These additives may be selected from known compounds and materials in accordance with the objects to be achieved.

The above-mentioned additives (plasticizers, fillers/pigments, mordants, conventional additives) may be added in a range of 0 to 30% by weight of total additive, based on the solid content of the water soluble polymers and/or gelatin in the ink receiving layer.

The particle sizes of the non water-soluble particulate additives should not be too high, since otherwise a negative influence on the resulting surface will be obtained. The used particle size should therefore preferably be less than 10 μm, more preferably 7 μm or less. The particle size is preferably above 0.1 μm, more preferably about 1 μm or more for handling purposes.

The gelatin is preferably used in a total amount of from 1 to 30 g/m², and more preferably from 2 to 20 g/m². The amount of hydrophilic polymer is typically in the range from 100 mg/m² to 30 g/m² and more preferably between 200 mg/m² and 20 g/m². When preparing the ink-jet-receiving sheet by coating a plurality of ink receiving layers, each ink-receiving layer comprises an amount of gelatin ranging from 0.5 to 10 g/m².

If desired, the gelatin can be cross-linked in the image-recording elements of the present invention in order to impart mechanical strength to the layer. This can be done by any cross-linking agent known in the art.

For gelatin, there is a large number of known cross-linking agents—also known as hardening agents. Examples of the hardener include aldehyde compounds such as formaldehyde and glutaraldehyde, ketone compounds such as diacetyl and chloropentanedion, bis(2-chloroethylurea), 2-hydroxy-4,6-dichloro-1,3,5-triazine, reactive halogen-containing compounds disclosed in U.S. Pat. No. 3,288,775, carbamoyl pyridinium compounds in which the pyridine ring carries a sulphate or an alkyl sulphate group disclosed in U.S. Pat. No. 4,063,952 and U.S. Pat. No. 5,529,892, divinylsulfones, and the like. These hardeners can be used singly or in combination. The amount of hardener used, preferably ranges from 0.1 to 10 g, and more preferably from 0.1 to 7 g based on 100 g of gelatin contained in the ink-receiving layer. For PVA, for example, it is preferable to choose a cross-linking agent selected from borax, glyoxal, dicarboxylic acids and the like.

The process for preparing a recording medium according to the invention comprises the steps of:

preparation of an oil in water emulsion or a dispersion comprising an optical brightening agent and preparation of an oil in water emulsion or a dispersion comprising a UV absorbing agent;

preparation of at least two aqueous mixtures comprising e.g. one or more water soluble polymers and/or gelatin;

optionally preparation of an aqueous mixture comprising a modified gelatin for the overlayer;

mixing the oil in water emulsion or the dispersion comprising an optical brightening agent with one of said mixtures;

mixing the oil in water emulsion or the dispersion comprising a UV absorbing agent with one of said mixtures; and

coating said mixtures consecutively or simultaneously on a support, whereby the mixture comprising the UV absorbing agent is coated in between said support and the mixture comprising the optical brightener.

The resulting formulations for overlayer(s), optical brightener layer(s), UV absorbing layer(s) and underlayer(s) can be coated consecutively or simultaneously to a support by any method known in the art. The coating methods are for example, a curtain coating, an extrusion coating, an air-knife coating, a slide coating, a roll coating method, reverse roll coating, dip coating processes and a rod bar coating.

The support used in this invention may suitably be selected from a paper, a photographic base paper, a paper coated on both sides with a polymer layer, pigment coated paper, a synthetic paper or a plastic film in which the top and back coatings are balanced in order to minimise the curl behaviour.

The backside coating comprises gelatin or a water soluble polymer in an amount ranging preferably from 1 to 20 g/m², more preferably from 4 to 15 g/m². The optimum amount of the backside coating depends on the type of gelatin, the type of water soluble polymer and on the composition of the layers at the ink receiving side of the medium and is determined experimentally. The preferred polymer for the backside coating is gelatin.

An important characteristic of the inkjet recording medium is the gloss. It has been found that the gloss of the medium can be improved by selecting the appropriate surface roughness of the used support. It was found, that providing a support having a surface roughness characterised by the value Ra being less than 1.0 μm, preferably below 0.8 μm a very glossy medium can be obtained. A low value of the Ra indicates a smooth surface. The Ra is measured according to DIN 4776; software package version 1.62 with the following settings:

(1) Point density 500 P/mm (2) Area 5.6×4.0 mm² (3) Cut-off wavelength 0.80 mm (4) Speed 0.5 mm/sec., using a UBM equipment.

The base paper to be used as the support for the present invention is selected from materials conventionally used in high quality printing paper. Generally it is based on natural wood pulp and if desired, a filler such as talc, calcium carbonate, TiO₂, BaSO₄, and the like can be added. Generally the paper also contains internal sizing agents, such as alkyl ketene dimer, higher fatty acids, paraffin wax, alkenylsuccinic acid, epichlorhydrin fatty acid amid and the like. Further the paper may contain wet and dry strength agents such as a polyamine, a poly-amide, polyacrylamide, poly-epichlorhydrin or starch and the like. Further additives in the paper can be fixing agents, such as aluminium sulphate, starch, cationic polymers and the like. The Ra value for a normal grade base paper is well above 1.0 μm typically above 1.3 μm. In order to obtain a base paper with a Ra value below 1.0 μm such a normal grade base paper can be coated with a pigment. Any pigment can be used. Examples of pigments are calcium-carbonate, TiO₂, BaSO₄, clay, such as kaolin, styrene-acrylic copolymer, Mg—Al-silicate, and the like or combinations thereof. The amount being between 0.5 and 35.0 g/m² more preferably between 0.5 and 20.0 g/m². This pigmented coating can be applied as a pigment slurry in water together with a suitable binders like styrene-butadiene latex, methyl methacrylate-butadiene latex, polyvinyl alcohol, modified starch, polyacrylate latex or combinations thereof, by any technique known in the art, like dip coating, roll coating, blade coating or bar coating. The pigment coated base paper may optionally be calendered. The surface roughness can be influenced by the kind of pigment used and by a combination of pigment and calendering. The base pigment coated paper substrate has preferably a surface roughness between 0.4 and 0.8 μm. If the surface roughness is further reduced by super calendaring to values below 0.4 μm the thickness and stiffness values will generally become below an acceptable level.

The ink receiving multilayer of the present invention can be directly applied to the pigment coated base paper. In another embodiment, the pigment coated base paper having a pigmented top side and a back-side is provided on both sides with a polymer resin through high temperature co-extrusion giving a laminated pigment coated base paper. Typically temperatures in this (co-) extrusion are above 280° C. but below 350° C. The preferred polymers used are poly olefins, particularly polyethylene. In a preferred embodiment the polymer resin of the top side comprises compounds such as an opacifying white pigment e.g. TiO₂ (anatase or rutile), ZnO or ZnS, dyes, coloured pigments, including blueing agents, like e.g. ultramarine or cobalt blue, adhesion promoters, optical brighteners, antioxidant and the like to improve the whiteness of the laminated pigment coated base paper. By using other than white pigments a variety of colors of the laminated pigment coated base paper can be obtained. The total weight of the laminated pigment coated base paper is preferably between 80 and 350 g/m². The laminated pigment coated base paper shows a very good smoothness, which after applying the ink receiving layer of the present invention results in a recording medium with excellent gloss.

Examples of the material of the plastic film are polyolefin's such as polyethylene and polypropylene, vinyl copolymers such as polyvinyl acetate, polyvinyl chloride and polystyrene, polyamide such as 6,6-nylon and 6-nylon, polyesters such as polyethylene terephthalate, polyethylene-2 and 6-naphthalate and polycarbonate, and cellulose acetates such as cellulose triacetate and cellulose diacetate. The support may have a gelatin subbing layer to improve coatability of the support. The support may be subjected to a corona treatment in order to improve the adhesion between the support and the ink receiving layer. Also other techniques, like plasma treatment can be used to improve the adhesion.

The swellable ink-receiving layer has a dry thickness from 1 to 50 micrometers, preferably from 5 to 25 and more preferably between 8 and 20 micrometers. If the thickness of said ink receiving layer is less than 1 micrometer, adequate absorption of the solvent will not be obtained. If, on the other hand, the thickness of said ink receiving layer exceeds 50 micrometers, no further increase in solvent absorptivity will be gained.

The recording medium of this invention can be used in any printing application, where a photographic quality print is required. Although the invention is described herein with particular reference to inkjet printing, it will be apparent to the skilled person that the high quality recording media of the present invention are not limited to inkjet recording media (viz. media suitable to be printed on using inkjet printers), but that it is within the scope of the present invention to provide recording media that are suitable for creating high quality images by using other techniques as well, such as Giclée printing, colour copying, screen printing, gravure, dye-sublimation, flexography, and the like.

The media of the present invention display an excellent light fastness, or dye stability, after exposure to (ambient) light. Light fastness may be assessed by the protocol set out in the examples herein below. Typically, the media of the present invention have more than 80% remaining density.

Furthermore, the media of the present invention may have an excellent coloration behavior, the coloration of the media upon storage at typical storage conditions being minimal. The coloration (viz. the “yellowing” of the white parts of the media of the present invention upon aging) may be assessed using a protocol in which L, a*, b* values are measured by a spectrophotometer (e.g. a MINOLTA CM-1000R). The media of the present invention may have a ΔE (whiteness difference, expressed as b* values measured on a spectrophotometer, before and after aging) value after two weeks of storage at 50° C. and 40% relative humidity of less than 5, preferably 2 or less.

The present invention will be illustrated in detail by the following non-limiting examples. Unless stated otherwise, all ratios given are based on weight.

### EXAMPLES

A. Preparation of Underlayer Solution ‘A’ of the Ink Receiving Layer.

A 20 wt. % solution of a lime processed gelatin was prepared at pH 9. An aqueous solution of 10 wt % polyethylene oxide (PEO) having molecular weight of approximately 100 000 (from Sigma Aldrich chemicals, the Netherlands), was also prepared at pH 9. A homogeneous mixture (viz. no phase separation occurred), of gelatin and PEO having a weight ratio of 6:1 was made by adding 143 weight parts of said PEO solution and 429 weight parts of water into 428 weight parts of said gelatin solution at a temperature of 40° C. This mixture was agitated gently for about 30 minutes.

B. Preparation of Underlayer Solution ‘B’ of the Ink Receiving Layer.

Underlayer solution ‘B’ was prepared in the same way as underlayer solution ‘A’, except that PEO was replaced by polyvinyl pyrollidone (PVP) having a molecular weight of 30 000 Daltons (ICN Biochemicals).

C. Preparation of the Overlayer Solution ‘C’ of the Ink Receiving Layer.

A solution containing 50 weight parts of Gelita® Imagel MA (dodecenylsuccinic modified acid treated gelatin from Stoess GmbH, Germany with a modification degree of 40%), 1 weight part of Zonyl® FSN surfactant (a non-ionic fluorocarbon type of surfactant) and 949 weight parts of water was prepared at 40° C. The pH of the solution was adjusted to 8.5 by adding NaOH.

D. Preparation of an Oil in Water Emulsion-‘D’

120 Gram of UV-absorbing agents (a mixture of UV-1/UV-2/UV-3/UV-4=2/1/1/1; see chemical formulae hereinbelow for the definitions of UV-1 to UV-4) 40 gram dibuthyl phtalate, and 20 gram of a 20% sorbitane monolaurate methanol solution were mixed in 100 ml of ethyl acetate at 65° C. The solution was dispersed in 500 ml of an aqueous solution containing 20% lime bone gelatin by weight using a homogeniser. After emulsification the solution was diluted to 1000 g by water.

The size of the dispersed oil droplets was determined by the disc centrifuge particle size measurement, and the mean diameter was 130 nm.

E. Preparation of an Oil in Water Emulsion-‘E’

50 Gram of optical brightener OB-1 (see chemical formula hereinbelow), 60 gram dibuthyl phtalate, and 30 gram of a 20% sorbitan monolaurate methanol solution were mixed in 100 ml of ethyl acetate at 65° C. The solution was dispersed in 450 ml of an aqueous solution containing 22% lime bone gelatin by weight using a homogeniser.

After emulsification the solution was diluted to 1000 g by water. The size of the dispersed oil droplets was determined by the disc centrifuge particle size measurement, and the mean diameter was 200 nm.

The underlayer(s) and overlayer solutions mentioned above were fed into a slide coating machine, commonly known in the photographic industry, and coated on a photographic grade paper having polyethylene laminated at both sides. The flow of the under and overlayers were selected such that, after drying, a total solid content of the underlayer(s) (=gelatin+other water soluble polymer) between 8 to 25 g/m² was obtained and a total solid content of the overlayer between 0.5 and 5 g/m². After coating, the solution was chilled at a temperature of ca. 12° C. to set the gelatin and then dried with dry air at a maximum temperature of 40° C.

These examples describe one way of applying the invention. An overview of the layer structures of these examples is given in table 1, below.

### Example 1—Comparative Example

In the order recited, the following layers were coated on a laminated substrate:

Underlayer 1: 50 cc/m2 of underlayer solution ‘A’

Underlayer 2: 100 cc/m² of a 1:1 mixture of underlayer solutions ‘A’ and ‘B’.

Overlayer 1: 40 cc/m2 of overlayer solution ‘C’

This gives an inkjet recording material with good general properties and has a reasonable whiteness, which is getting increasingly worse upon aging at high temperature and humidity. The material also has poor dye stability under prolonged exposure to light.

### Example 2—Comparative

The sample was prepared in the same way as Example 1, except for underlayer 2:

40 weight parts of oil in water emulsion ‘D’ was mixed with 480 weight parts of underlayer solution ‘A’ and 480 weight parts of underlayer solution ‘B’. Of the resulting mixture 100 cc/m ² was coated.

This material has better dye stability because of the presence of UV-absorbers and anti-oxidant but its whiteness gets worse upon aging even more than in Example 1, due to the yellowing of the UV-agents.

### Example 3—Comparative

The sample was prepared as in Example 2, except for underlayer 1:

240 weight parts of oil in water emulsion ‘E’ was mixed with 760 weight parts of underlayer solution ‘A’. Of the resulting mixture 50 cc/m² was coated.

This material has better dye stability, and although better than the previous examples, whiteness remains poor upon aging.

### Example 4—Inventive

The sample was prepared as in Example 1, except for underlayer 1:

80 Weight parts oil in water emulsion ‘D’ was mixed with 920 weight parts underlayer solution ‘A’ and of the resulting mixture 50 cc/m² was coated; and underlayer 2:

120 weight parts oil in water emulsion ‘E’ was mixed with 440 weight parts of underlayer solution ‘A’ and 440 weight parts of underlayer solution ‘B’ and of the resulting mixture 100 cc/m² was coated.

This material has even better dye stability, and whiteness aging has significantly improved.

TABLE 1

| Ex. 1 | Ex. 2 | Ex. 3 | Ex. 4 |
|---|---|---|---|
| comparison | comparison | comparison | inventive |
| Overlayer(C) | Overlayer(C) | Overlayer(C) | Overlayer(C) |
| Underlayer 2 | +1.4 mmol/m² UV-1˜4 | +1.4 mmol/m² UV-1-4 | +0.6 gram/m2 OB-1 |
| (8.3 g/m² gelatin) | | | |
| Underlayer 1 | same as ex. 1 | +0.6 gram/m2 OB-1 | +1.4 mmol/m2 UV-1-4 |
| (4.3 g/m² gelatin) | | | |
| Laminated base | Laminated base | Laminated base | Laminated base |

Evaluation of the Printed Image on the Media

The ink-jet media prepared by the above mentioned formulation and said coating process, were printed with a standard image comprising black, cyan, magenta and yellow bars. The image contained also two pictures; including a portrait picture and a composition picture. The image was printed at a room conditions (23° C. and 48% Relative Humidity (RH)) and the printed materials were kept at this condition for at least 1 hour to dry.

A HP Deskjet® 995c was used to print the images by using the following settings:

Print quality: best

Selected Paper type: HP premium plus photo paper, glossy

Other parameters were according to the factory setting.

Evaluation Methods

1. Light Fastness

Light fastness, or dye stability, was measured after exposing the printed samples to xenon light (85,000 lx) for 144 hours (Atlas Weather-O-Meter C I 35A, manufactured by Atlas (Illinois, U.S.A.)). The image density of the colors on the printed area is measured before and after the xenon irradiation by a reflection densitometer (X-Rite 310TR) and expressed as the remaining color-density percentage. The following classification has been defined:

O: more than 80% remaining density

Δ: 80-60% remaining density

X: less than 60% remaining

TABLE 2

| | #1 | #2 | #3 | #4 |
|---|---|---|---|---|
| | comparison | comparison | comparison | Inventive |
| Lightfastness | X | Δ | Δ | ◯ |

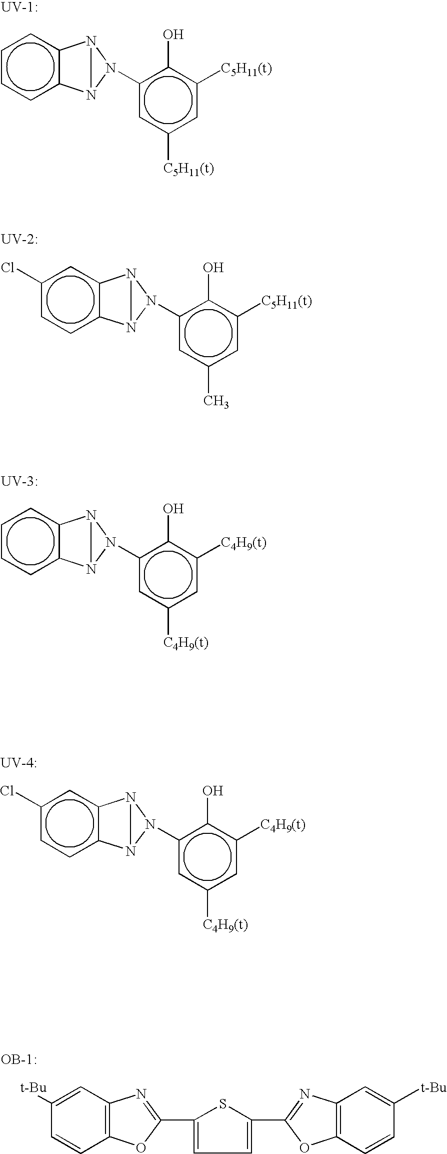

1. A recording medium comprising a support and an ink-receiving layer adhered to said support, wherein the ink-receiving layer is a multilayer comprising at least two layers, wherein one layer comprising an optical brightener is further away from said support than another layer which comprises a UV absorbing agent.

2. The medium according to claim 1, wherein:
the layer comprising the UV absorbing agent is substantially free from optical brightener; or
wherein the layer comprising the optical brightener is substantially free from UV absorbing agent;
or both.

3. The medium according to claim 1, wherein said optical brightener, said UV absorbing agent, or both are fixed to their respective layers.

4. The medium according to claim 1, wherein said optical brightener, said UV absorbing agent, or both are not water soluble.

5. The medium according to claim 1, wherein said optical brightener is selected from the group consisting of thiophenes, stilbenes, triazines, imidazolones, pyrazolines, triazoles, bis(benzoxazoles), coumarins, acetylenes and mixtures thereof.

6. The medium according to claim 1, wherein said optical brightener is used in an amount of 0.01 to 5.0 g/m².

7. The medium according to claim 1, wherein said UV absorbing agent comprises an absorbing group that has an absorption of less than 400 nm.

8. The medium according to claim 7, wherein said UV absorbing group is selected from the families of cinnamates, hydroxybenzophenones, benzotriazoles, aminobutadienes and combinations thereof.

9. The medium according to claim 7, in which the UV absorbing group is used in an amount of 0.1 to 5.0 g/m².

10. The medium according to claim 1, in which the ink-receiving layer comprises an anti-oxidant.

11. The medium according to claim 10, in which the anti-oxidant is selected from the group of substituted phenolic and blocked phenolic compounds, phenolic thiane derivatives, substituted bisphenols, sterically hindered amines, substituted hydrochinon and agents having molecular structures which are based upon a cresol type of molecule, a pyrogallol type, a cathechol type, or a 2,4-disulphonamidophenol type.

12. The medium according to claim 10, in which the anti oxidant is used in an amount of 0.05 to 2.5 g/m².

13. The medium according to claim 1, wherein the ink receiving layer comprises at least three layers: one overlayer which is further away from said support than said layer comprising the optical brightener and said layer comprising a UV absorbing agent, which overlayer comprises at least one type of modified gelatin selected from the group consisting of acetylated gelatin, phthalated gelatin, alkyl quaternary ammonium modified gelatin, succinated gelatin, alkylsuccinated gelatin, gelatin chemically modified with N-hydroxysuccinimide ester of fatty acid, and combinations thereof.

14. The medium according to claim 13, wherein said modified gelatin comprises a C₅-C₂₅ alkyl group, a C₅-C₂₅ fatty acid group, or both; more preferably a C₇-C₁₈ alkyl group, a C₇-C₁₈ fatty acid group, or both.

15. The medium according to claim 13, in which the modified gelatin is used in an amount of 0.3 to 5.0 g/m², more preferably from 0.5 to 3.0 g/m².

16. The medium according to claim 1, wherein the ink receiving layer is substantially free from inorganic porous particles.

17. The medium according to claim 1, wherein the support is selected from a paper, a base paper, a pigment coated base paper, a laminated pigment coated base paper, a laminated paper, a synthetic paper or a film support.

18. The medium according to claim 1, wherein the support has a surface roughness Ra smaller than 1.0 μm, preferably smaller than 0.8 μm.

19. A process for preparing a recording medium comprising the steps of:
preparation of an oil in water emulsion or a dispersion comprising an optical brightening agent;
preparation of an oil in water emulsion or a dispersion comprising a UV absorbing agent;
preparation of at least two aqueous mixtures;
optionally preparation of an aqueous mixture comprising a modified gelatin for the overlayer;
mixing the oil in water emulsion or the dispersion comprising an optical brightening agent with one of said mixtures;
mixing the oil in water emulsion or the dispersion comprising a UV absorbing agent with one of said mixtures;
coating said mixtures consecutively or simultaneously on a support, whereby the mixture comprising the UV absorbing agent is coated in between said support and the mixture comprising the optical brightener; and
drying the coated support.

20. A method of forming a permanent, precise ink-jet image comprising the steps of:
providing a medium as defined in claim 1; and
bringing ink-jet ink into contact with the medium in the pattern of a desired image.

21. The medium according to claim 1, wherein said optical brightener is used in an amount of from 0.02 to 1.0 g/m².

22. The medium according to claim 7, in which the UV absorbing group is used in an amount of from 0.2 to 1.0 g/m².

23. The medium according to claim 10, in which the anti oxidant is used in an amount of from 0.1 to 1.0 g/m².

24. The medium according to claim 13, wherein said modified gelatin comprises a C₇-C₁₈ alkyl group, a C₇-C₁₈ fatty acid group, or both.

25. The medium according to claim 13, in which the modified gelatin is used in an amount of from 0.5 to 3.0 g/m².
